(19) United States
(12) Patent Application Publication
(10) Pub. No.: US 2026/0170320 A1
(43) Pub. Date: Jun. 18, 2026

(54) HYBRID HOPFIELD NETWORKS BASED ON INJECTION-LOCKED LASERS

(71) Applicant: Microsoft Technology Licensing, LLC, Redmond, WA (US)

(72) Inventors: Tuomo Antero VON LERBER, Helsinki (FI); Lasse-Petteri LEPPÄNEN, Kirkkonummi (FI)

(21) Appl. No.: 18/978,940

(22) Filed: Dec. 12, 2024

(51) Int. Cl. G06N 3/067; G02F 1/11; G06N 3/044; H01S 3/10

(52) U.S. Cl. CPC G06N 3/0675; G02F 1/11; G06N 3/044; H01S 3/10092

(57) ABSTRACT

An optical Hopfield network system includes (i) an input system configured to generate an input signal; (ii) an optical Hopfield network configured to receive the input signal from the input system, the optical Hopfield network comprising: (a) a plurality of lasers, wherein each laser of the plurality of lasers is configured for injection-locked operation; and (b) one or more optical control devices configured to distribute light output by at least some of the plurality of lasers among at least some of the plurality of lasers in a controlled manner to contribute to injection locking of at least some of the plurality of lasers; and (iii) an output system configured to generate an output signal based on light received from the optical Hopfield network.

### BACKGROUND

Artificial intelligence (AI) solutions have been developed and applied to different problems and tasks in various industries. Many AI solutions are implemented using machine learning models that are trained on large datasets to recognize patterns, make predictions, provide classifications/labels, etc. These models can take on various forms and architectures, such as neural networks, decision trees, support vector machines, and/or others. Common neural network architectures include convolutional neural networks (CNNs), recurrent neural networks (RNNs), long short-term memory (LSTM) networks, and transformer models. Such models are often deployed on cloud platforms, servers, or specialized hardware.

Hardware acceleration refers to the use of specialized hardware components to perform specific computational tasks more efficiently than general-purpose central processing units (CPUs). Specialized hardware components can be designed to handle the parallel processing and high computational demands of machine learning tasks. Hardware acceleration can significantly speed up the training and/or inference of machine learning models, enabling faster and more efficient AI solutions.

The subject matter claimed herein is not limited to embodiments that operate only in environments such as those described above. Rather, this background is only provided to illustrate one example technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIG. 1 illustrates a conceptual representation of components of a hybrid Hopfield network.

FIG. 2 illustrates a conceptual representation of a visible layer and a hidden layer for a modern Hopfield network.

FIG. 3 illustrates a conceptual representation of a visible layer and a hidden layer for a hybrid Hopfield network.

FIG. 4 illustrates a schematic diagram of components of an example classical optical Hopfield network system.

FIG. 5 illustrates another schematic diagram of components of another example classical optical Hopfield network system.

FIG. 6 illustrates a schematic diagram of components of an example hybrid optical Hopfield network system.

FIG. 7 illustrates a schematic diagram of components of an optical Hopfield network system.

FIG. 8 illustrates example components of an example system that may include or be used to implement one or more disclosed embodiments.

### DETAILED DESCRIPTION

Disclosed embodiments are generally directed to a hybrid Hopfield network framework.

As indicated above, AI solutions have received significant attention and can be implemented using various types of hardware. Hopfield networks are a type of recurrent neural network used for associative memory tasks. Classical Hopfield networks include bidirectionally connected neurons, where each neuron is fully connected to all others with symmetric connection weights. Classical Hopfield networks operate by updating the states of the neurons to minimize an energy function. Patterns can be stored or encoded as attractor states in the weights of the connections between the neurons. A classical Hopfield network can retrieve stored attractor states by updating the states of the neurons to converge to a stable state close to a given input. This convergence via state updates can be regarded as relying on an energy landscape, where local minima correspond to stored patterns or attractor states.

Classical Hopfield networks are limited by the number of patterns they can store effectively (e.g., about 14% of the number of neurons). Modern Hopfield networks have been developed, which can have increased pattern storage capacity relative to classical Hopfield networks (e.g., by achieving a steeper energy landscape). In modern Hopfield networks, connections are formed between three or more neurons using hidden neurons. For instance, a modern Hopfield network can include (i) a visible layer with visible neurons and (ii) a hidden layer with hidden neurons, where each hidden neuron is connected to three or more of the visible neurons. In modern Hopfield networks, the relation between the visible neuron count and the memory capacity can be regarded as decoupled by moving some of the neurons into the hidden layer.

Although modern Hopfield networks can achieve greater memory capacity per visible neuron than classical Hopfield networks, modern Hopfield networks are often impractical for hardware acceleration. For instance, to use a modern Hopfield network to retrieve associative memories from a small 100×100 pixel image (10,000 pixels), a visible neuron count of 10,000 would be required. If each hidden neuron were connected to only three visible neurons (i.e., if the “synaptic group size” were equal to three), the required number of hidden layer neurons would be approximately 167 billion. Such a quantity of neurons is infeasible for hardware acceleration implementations.

At least some disclosed embodiments are directed to a hybrid Hopfield network framework that incorporates aspects of both classical and modern Hopfield networks. Similar to a modern Hopfield network, a hybrid Hopfield network can include both a visible layer with visible neurons and a hidden layer with hidden neurons. As will be described in more detail hereinafter, a hybrid Hopfield network can include a reduced quantity of hidden neurons in the hidden layer (e.g., relative to a modern Hopfield network), which can reduce the total neuron count and make the framework more amenable to hardware acceleration. Connections that are lost by omitting hidden neurons can be imitated, albeit imperfectly, via bidirectional connections between visible neurons in the visible layer.

The disclosed subject matter is also directed to optical neural network designs that can be used to accelerate classical, modern, and/or hybrid Hopfield networks. Injection-locked lasers may be used as neurons, and light may be used as an information carrier. Under an injection-locked laser framework, the output of one laser (sometimes referred to as a master laser) is used to control and/or synchronize the emission of another laser (sometimes referred to as a slave laser). Injection-locked operation can involve injecting a small amount of light from the master laser into the slave laser's cavity. If the frequency of the injected light is sufficiently close to the natural frequency of the slave laser, the slave laser's emission becomes locked to the frequency and phase of the master laser. As a result, the slave laser emits light with the same frequency, phase, and, often, polarization as the master laser, even though the power of the injected light is typically much lower than the power output of the slave laser. Injection locking of lasers can be achieved because the injected light from the master laser modifies the oscillation conditions within the slave laser's cavity. The slave laser's gain medium and cavity are forced to oscillate at the injected frequency, thereby overriding the laser's natural tendency to oscillate at its own independent frequency. This locked state can be maintained over a specific range of frequencies known as the locking range, which can depend on factors such as the power of the injected signal, the detuning between the master and slave frequencies, and the intrinsic properties of the lasers (e.g., linewidths, coupling efficiency, etc.).

At least some disclosed embodiments are directed to an optical Hopfield network that includes (i) lasers configured for injection-locked operation and (ii) one or more optical control devices that are configured to distribute light emitted by the lasers toward/among the various lasers in a controlled manner, which contributes to injection locking of the lasers. The lasers can be arranged to form a laser array, and the optical control device(s) can be implemented as one or more optical cross-connects, such as diffractive cross-connects.

The lasers of the Hopfield network (“neuron lasers”) can be further injection-locked via input light from an input system, which may itself include one or more input lasers. Light from the input laser(s) can be controlled/modulated to encode input data for inference and/or training of the optical Hopfield network. An output system can receive light from the Hopfield network and can be configured to generate an output signal based on the received light (e.g., via a photodiode array). In one example, the output system includes an acousto-optic modulator that wavelength-shifts light from the input laser(s). The wavelength-shifted light and the light received from the Hopfield network are detected by a photodiode matrix to facilitate detection of the beating heterodyne signal, which can provide the basis for the output signal of the system.

An optical Hopfield network system as disclosed herein can facilitate various benefits. For instance, an optical Hopfield network as disclosed herein can provide bidirectionality and massive parallelism in the connections between neurons (e.g., lasers acting as neurons). The neurons of the Hopfield network can be vastly more connected than conventional hardware-accelerated networks, which can provide highly accelerated inference times. An optical Hopfield network may be well-adapted for applications where the data is optical, such as in data centers. Additionally, lasers can provide convenient and strong nonlinearity, which is a basic characteristic for neural networks.

Having just described some of the various high-level features and benefits associated with the disclosed embodiments, attention will now be directed to the Figures. These Figures illustrate various conceptual representations, architectures, methods, and supporting illustrations related to the disclosed embodiments.

### Optical Hopfield Network Frameworks, Systems, and Components

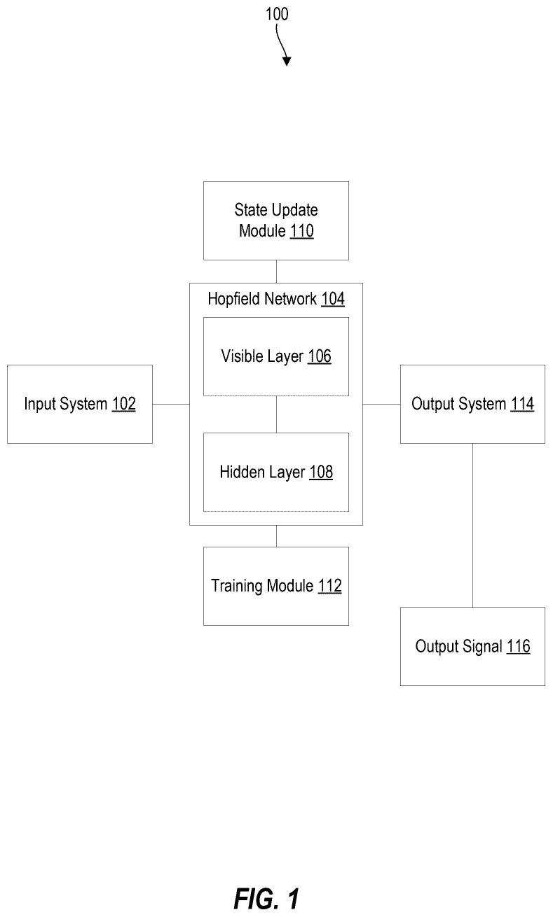

FIG. 1 illustrates a conceptual representation of components of a hybrid Hopfield network system 100. The hybrid Hopfield network system 100 shown in FIG. 1 includes an input system 102, which can be configured to provide an input signal to the Hopfield network 104. The input signal can include, by way of example, an image, a sequence, or a vector representation of patterns to be learned (e.g., stored as attractor states) or recalled during inference. The Hopfield network 104 of the hybrid Hopfield network system 100 includes a visible layer 106 and a hidden layer 108. The visible layer 106 includes visible neurons and can function as the interface between the input system 102 and the internal representation of the Hopfield network 104. The visible neurons of the visible layer 106 can hold states that correspond to the input signal received from the input system 102. The visible layer 106 can be configured to receive input patterns from the input system 102 (e.g., represented in the input signal) to facilitate pattern storage and/or pattern retrieval. The hidden layer 108 includes hidden neurons that can hold states corresponding to additional features or representations of patterns. As noted above, the hidden layer 108 can increase the capacity of the hybrid Hopfield network system 100 to store and retrieve patterns. As will be described in more detail hereinbelow, the Hopfield network 104 of the hybrid Hopfield network system 100 can include connections among the visible neurons and the hidden neurons, such as (i) connections between visible neurons of the visible layer 106 and (ii) connections between visible neurons of the visible layer 106 and hidden neurons of the hidden layer 108.

The states of the neurons of the Hopfield network 104 may be initialized based on the input signal from the input system 102 and can be updated during operation as part of the associative memory mechanism of the hybrid Hopfield network system 100. For instance, FIG. 1 illustrates the hybrid Hopfield network system 100 as including a state update module 110, which can iteratively adjust the neuron activations/states of the visible neurons of the visible layer 106 and the hidden neurons of the hidden layer 108 (after reception of an input pattern). The state update module 110 can perform state updates to minimize an energy function and can facilitate convergence of the Hopfield network 104 toward a stored attractor state that corresponds to a stored memory pattern (or the pattern/state most closely associated with the input signal received from the input system 102). Iterative update rules derived from energy minimization frameworks, gradient-based optimization, and/or other update techniques can be implemented to achieve convergence on a stored pattern.

In the example shown in FIG. 1, the hybrid Hopfield network system 100 further includes a training module 112, which can be configured to facilitate learning of weights for connections among the visible and hidden neurons of the Hopfield network 104 based on input signals/data, which can achieve storage of input patterns as stored attractor states. The training module 112 may encode patterns into the memory of the Hopfield network 104 by adjusting connection weights in a manner that minimizes a loss function (e.g., using backpropagation, stochastic gradient descent, and/or other principles from deep learning). The hybrid Hopfield network system 100 shown in FIG. 1 further includes an output system 114, which can provide an output signal 116 based on the states of the visible neurons in the visible layer 106, representing a retrieved attractor state or result of a memory association or training process.

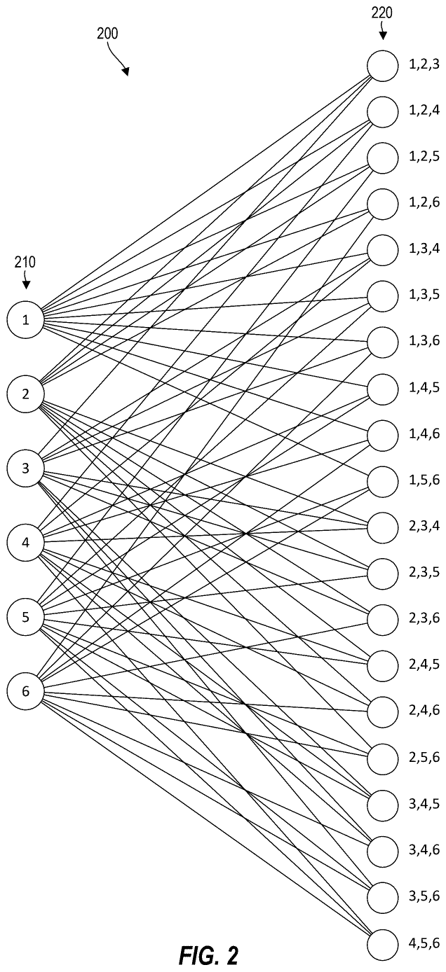

Additional details will now be provided concerning the visible neurons of the visible layer 106 and the hidden neurons of the hidden layer 108. By way of context, FIG. 2 illustrates a conceptual representation of a visible layer 210 and a hidden layer 220 of a modern Hopfield network 200. The visible and hidden neurons of the modern Hopfield network 200 are represented in FIG. 2 as circles with a white fill, with connections between the visible neurons and hidden neurons depicted as straight lines. As is illustrated in FIG. 2, no direct connections exist between the visible neurons of the visible layer 210, and each hidden neuron of the hidden layer 220 is connected to a quantity of visible neurons of the visible layer 210. The quantity of visible neurons that each individual hidden neuron is connected to is referred to herein as the “synaptic group size.”

In the example shown in FIG. 2, the hidden layer 220 of the modern Hopfield network 200 has a quantity of hidden neurons corresponding to a full hidden neuron count. As used herein, a “full hidden neuron count” refers to the quantity of hidden neurons needed to accommodate all possible combinations of connections (without regard to order of selection) between the hidden neurons and the visible neurons, for a given quantity of visible neurons and synaptic group size. For instance, FIG. 2 illustrates the visible layer 210 as including 6 visible neurons, with each visible neuron being indexed with a respective number “1”, “2”, “3”, “4”, “5”, or “6”. A synaptic group size of 3 is used in the example modern Hopfield network 200 of FIG. 2. Each hidden neuron of the hidden layer 220 is labeled on its right with the indices of the visible neurons connected to the hidden neuron. For instance, the top hidden neuron of the hidden layer 220 is labeled with “1,2,3”, indicating that this hidden neuron is connected to visible neurons 1, 2, and 3. The hidden layer 220 of the modern Hopfield network 200 shown in FIG. 2 includes 20 neurons, which is sufficient to accommodate all possible combinations of connections with visible neurons 1, 2, 3, 4, 5, and 6.

For a given synaptic group size and quantity of visible neurons, the full hidden neuron count can be obtained by the formula for combinations, such as by:

$$m = ( \begin{matrix}n \\ k\end{matrix} ) = \frac{n !}{k ! ( n - k ) !}$$

where m represents the full hidden neuron count, n represents the quantity of visible neurons in the visible layer, and k represents the synaptic group size. The full hidden neuron count may be defined as a ratio of (i) a factorial of the quantity of visible neurons to (ii) a product of (a) a factorial of the quantity of the synaptic group size and (b) a factorial of a difference between the quantity of visible neurons and the synaptic group size.

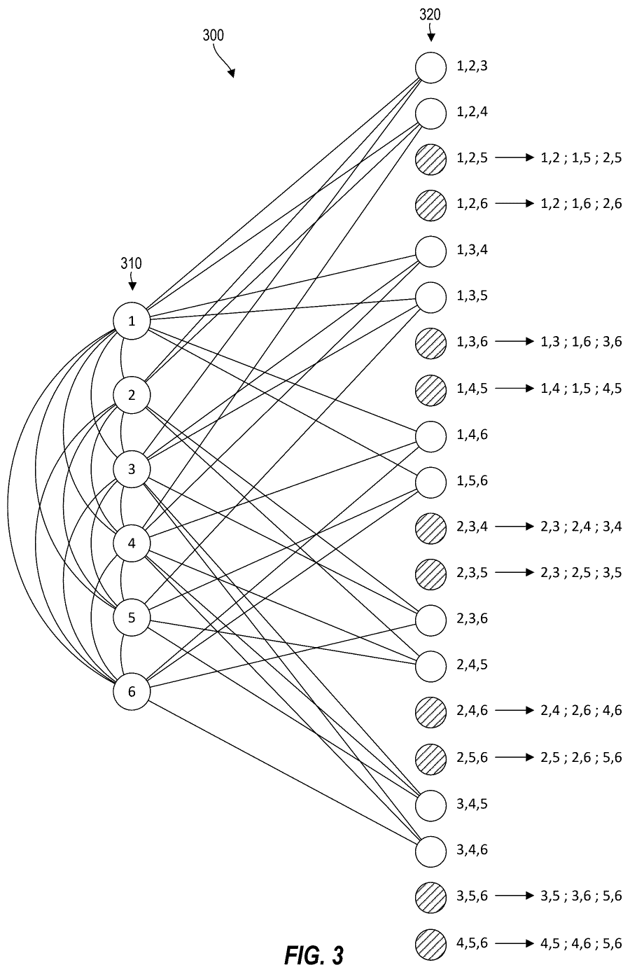

FIG. 3 illustrates a conceptual representation of a visible layer 310 and a hidden layer 320 for a hybrid Hopfield network 300, which includes characteristics representative of the Hopfield network 104 for the hybrid Hopfield network system 100 as described hereinabove with reference to FIG. 1. In FIG. 3 (similar to FIG. 2), the visible and hidden neurons are represented as white-filled circles, connections between the visible neurons and the hidden neurons are depicted as straight lines, the visible layer 310 includes 6 visible neurons that are numerically indexed (1 through 6), and each hidden neuron is labeled to its right with the indices of the visible neurons connected thereto.

In contrast with the hidden layer 220 of modern Hopfield network 200 described above, the hidden layer 320 of the hybrid Hopfield network 300 has fewer hidden neurons than its corresponding full hidden neuron count. The hidden layer 320 of the hybrid Hopfield network 300 shown in FIG. 3 has ten total hidden neurons. This is conceptually shown in FIG. 3 via “included” hidden neurons that contribute to the quantity of hidden neurons in the hidden layer 320 and “omitted” hidden neurons that do not contribute to this quantity. The included hidden neurons are represented by white-filled circles in the hidden layer 320 that are connected via lines to visible neurons of the visible layer 310. The omitted hidden neurons are represented as circles with a diagonal line pattern fill and that are not connected via lines to any of the visible neurons. Similar to the included hidden neurons, each of the omitted hidden neurons is labeled to its right with indices of visible neurons, which indicate the combination of visible neurons to which the omitted hidden neuron could be connected (e.g., if it were to be “included” instead).

With fewer hidden neurons, the hybrid Hopfield network 300 can be better suited for hardware acceleration and/or can have a lower resource burden than the modern Hopfield network 200. However, omitting some hidden neurons as described above with reference to FIG. 3 can result in the hybrid Hopfield network 300 having a shallower energy landscape than the modern Hopfield network 200, resulting in at least partially degraded pattern storage and/or retrieval capabilities and/or performance. A hybrid Hopfield network 300 can thus at least partially compensate for the omitted hidden neurons by implementing bidirectional connections between the visible neurons of the visible layer 310 (e.g., similar to a classical Hopfield network, as described above). Implementing bidirectional connections between visible neurons can contribute to an improved energy landscape for a hybrid Hopfield network 300 in a manner that maintains suitability for hardware acceleration.

FIG. 3 illustrates the visible neurons of the visible layer 310 as being bidirectionally connected, which is represented in FIG. 3 by the curved lines connecting the visible neurons to one another. The inclusion of the bidirectional connections between the visible neurons in the visible layer 310 of the hybrid Hopfield network 300 can at least partially compensate for the connections lost by omitting hidden neurons from the hidden layer 320. For example, FIG. 3 illustrates an omitted hidden neuron labeled “1,2,5”, indicating that a hidden neuron that connects visible neurons 1, 2, and 5 is not included in the hidden layer 320 of the hybrid Hopfield network 300. FIG. 3 includes a rightward arrow extending from the “1,2,5” label toward another label (i.e., “1,2; 1,5; 2,5”) indicating the bidirectional visible neuron connections (i.e., bidirectional connections between visible neurons 1 and 2, between visible neurons 1 and 5, and between visible neurons 2 and 5) that at least partially compensate for the omission of a hidden neuron connecting visible neurons 1, 2, and 5.

In the example shown in FIG. 3, the hidden layer 320 of the hybrid Hopfield network 300 includes 10 hidden neurons, which is 50% of the full hidden neuron count (given the 6 visible neurons and the synaptic group size of 3). A hybrid Hopfield network can include a reduced quantity of hidden neurons relative to the full hidden neuron count. For instance, the quantity of hidden neurons in the hidden layer of a hybrid Hopfield network can be less than 90%, less than 80%, less than 70%, less than 60%, less than 50%, less than 40%, less than 30%, less than 20%, or less than 10% of the full hidden neuron count.

A hybrid Hopfield network system 100 (e.g., where the Hopfield network 104 includes characteristics of the hybrid Hopfield network 300 discussed with reference to FIG. 3) may be implemented in various ways. For example, the input system 102, visible layer 106, the hidden layer 108, the state update module 110, the training module 112, and/or the output system 114 may be represented in computer-executable instructions (e.g., instructions 806) that are stored by one or more computer-readable recording media (e.g., storage 804) that are executable by one or more processors (e.g., processor(s) 802, such as neural processor units, graphics processing units, central processing units, and/or other types of processing units) to facilitate reception of an input pattern by the visible layer 106 and generation of the output signal 116 by the output system 114. In some instances, the visible layer 106 and/or the hidden layer 108 are represented as a set of lasers configured for injection-locked operation, where connections among the visible neurons and the hidden neurons (e.g., between visible neurons and between visible and hidden neurons) are represented as one or more optical control devices such as diffractive cross-connects, spatial light modulators, micro-lenses with controlled transmission characteristics, holographic diffractive elements, light scattering layers, and/or other components. When the visible layer 106 and/or the hidden layer 108 are represented as a set of lasers configured for injection-locked operation, the lasers may also comprise and/or fulfill the function of the state update module 110, effectuating state updates automatically and asynchronously.

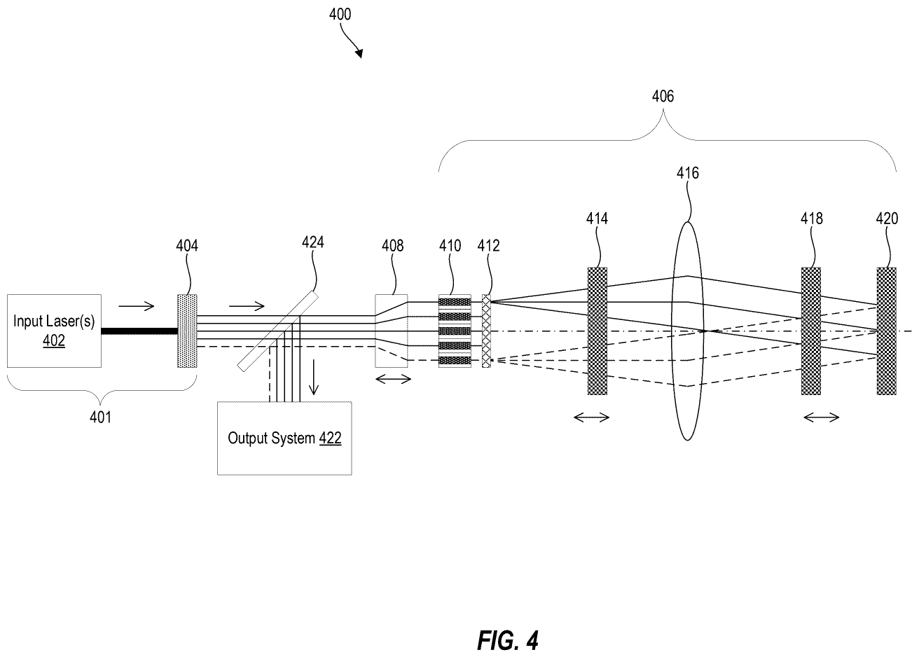

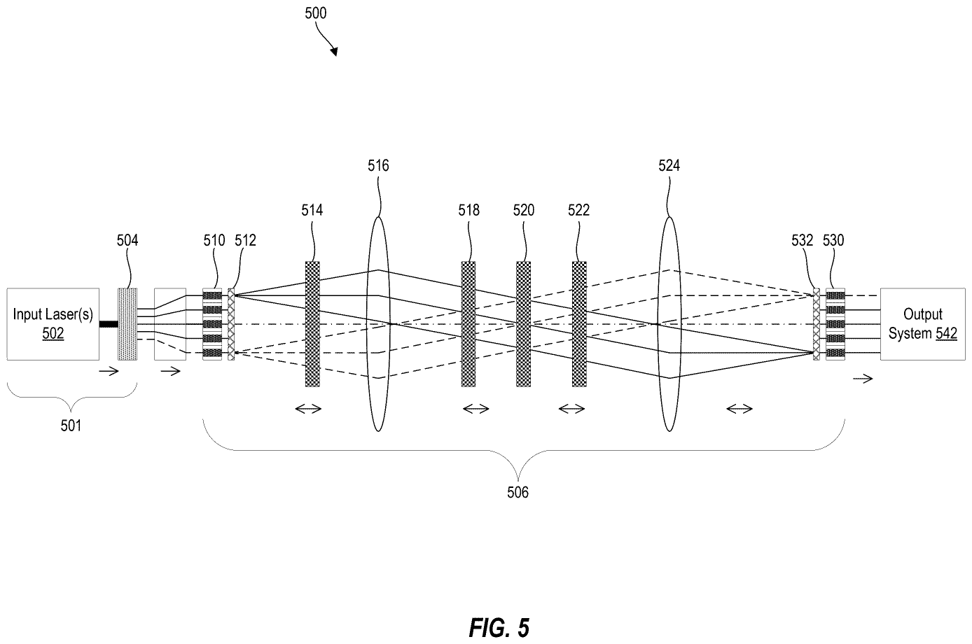

Attention will now be directed to FIGS. 4-7, which illustrate schematic diagrams of components of example optical Hopfield network systems. The schematic diagrams include single or double-headed arrows adjacent to the beam representations and/or components, which indicate beam propagation direction. FIGS. 4 and 5 illustrates schematic diagrams of components of example classical optical Hopfield network systems. In FIG. 4, the classical optical Hopfield network system 400 includes an input system 401 that has input laser(s) 402 and spatial light modulator(s) 404. The input laser(s) 402 can take on any suitable form. In one example embodiment, the input laser(s) 402 comprise one or more a Nd:YAG 1064 nm high temporal coherence lasers. The input laser(s) 402 can be configured such that a single (higher-coherence) reference laser is arranged to cause injection locking of one or more other (lower-coherence) input lasers organized in an array or matrix that directs light toward the spatial light modulator(s) 404.

The spatial light modulator(s) 404 can comprise a liquid crystal spatial light modulator, LiNbO3 modulator, and/or other types. The spatial light modulator(s) 404 can be configured to modulate/encode light generated by the input laser(s) 402 with input data to provide an input signal, which is directed toward the optical implementation of the classical optical Hopfield network 406. One will appreciate that the input system 401 can include additional or alternative components (e.g., optics 408 for adjusting the beam size, one or more lenses or microlenses, diffractive elements, mirrors, etc.).

The classical optical Hopfield network 406 shown in FIG. 4 includes visible neuron lasers 410 that are adapted to receive the input signal from the input system 401. The visible neuron lasers 410 represent visible neurons of a visible layer for a classical Hopfield network. In the example shown in FIG. 4, the visible neuron lasers 410 include one visible neuron laser per visible neuron of the visible layer for the Hopfield network represented by the classical optical Hopfield network. For example, where the underlying Hopfield network design includes n visible neurons in the visible layer, the visible neuron lasers 410 may include n visible neuron lasers. The visible neuron lasers 410 can be coherent over a time scale of interest (e.g., via injection locking by the input laser(s) 402) and can be configured to emit light with substantially the same wavelength as one another (e.g., within a few nanometers) and can be configured to operate with a consistent polarization state (e.g., linear polarization). The visible neuron lasers 410 be arranged in an array or matrix of any structure (e.g., a rectangular lattice, a triangular lattice, a column, a honeycomb lattice, an irregular lattice, etc.). FIG. 4 illustrates the classical optical Hopfield network 406 as including a micro-lens array 412, which may be implemented to impart desired spatial coherence, beam divergence, and/or other characteristics on the light emitted by the visible neuron lasers 410 for optical interaction with downstream components.

The visible neuron lasers 410 of the classical optical Hopfield network 406 can be configured for injection-locked operation. The classical optical Hopfield network 406 shown in FIG. 4 further includes optical control devices 414, 416, 418, and 420, which are configured to distribute light output by the visible neuron lasers 410 among the visible neuron lasers 410 in a controlled manner, which can contribute to injection locking of the visible neuron lasers 410. In the example shown in FIG. 4, the optical control devices 414, 416, 418, and 420 optically connect each of the visible neuron lasers 410 to each other of the visible neuron lasers 410 (e.g., similar to the bidirectional connections for classical Hopfield networks as described hereinabove). The optical control devices 414, 416, 418, and 420 can thus facilitate injection locking of the visible neuron lasers 410. For instance, a particular visible neuron laser from the set of visible neuron lasers 410 can receive light output by the other visible neuron lasers and directed by the optical control devices 414, 416, 418, and 420, which light can be represented as Z=Σzᵢ, where zᵢ represents the 2-dimensional complex vector indicating electric field amplitudes of the two polarization modes (Jones vector) for light from each of the visible neuron lasers 410 that is received by the particular visible neuron laser. The light received by the particular visible neuron laser can cause injection locking of the particular visible neuron laser, which can be characterized as weak, strong, or moderate (e.g., exhibiting combined characteristics/components of weak and strong injection locking). Under weak injection locking, the particular visible neuron laser can output light with a two-dimensional complex electric field amplitude E(Z) characterized by:

$$E ( Z ) ∝ \frac{Z}{‖ Z ‖} .$$

Under strong injection locking, the particular visible neuron laser can output light with a two-dimensional complex electric field amplitude E(Z) characterized by:

$$E ( Z ) ∝ Z .$$

The coupling between any two of the visible neuron lasers of the set of visible neuron lasers 410 can be reciprocal. For instance, the coupling efficiency of one visible neuron laser a and another visible neuron laser b that are coupled via the optical control devices 414, 416, 418, and 420 can be characterized as w_{ab}=w_{ba}, where w_{ab} represents the coupling coefficient from visible neuron laser a to visible neuron laser b and where w_{ba} represents the coupling coefficient from visible neuron laser b to visible neuron laser a.

This injection-locking of the visible neuron lasers 410 (accomplished via the optical control devices 414, 416, 418, and 420) can thus achieve coupling among the visible neuron lasers 410 while still preserving the nonlinearity inherent in injection-locked lasers, enabling the visible neuron lasers 410 to operate as nodes or neurons for a Hopfield network to perform machine learning or AI operations. The input signal from the input system 401 can additionally contribute to injection locking of the visible neuron lasers 410.

The optical control devices 414, 418, and 420 shown in FIG. 4 can comprise one or more optical cross-connects, such as diffractive cross-connects, spatial light modulators, lenses with controlled transmission characteristics, holographic or other diffractive optical elements, digital micromirror devices, liquid crystal-based devices, etc. The inter-laser optical connections facilitated by the optical control devices 414, 418, and 420 can be governed by weights that are trained or tuned via associative memory training methods (e.g., Hebbian learning, Storkey learning, and/or others). For example, an input pattern may be modulated/encoded into the input signal via the spatial light modulator(s) 404. The optical control devices 414, 418, and 420 can be initially controlled with initialized weights for defining the optical connections between the visible neuron lasers 410. These weights can be iteratively adjusted/updated (e.g., based on analysis of the output signal of the classical optical Hopfield network system 400), resulting in iterative changes to the optical connections between the visible neuron lasers, which can facilitate encoding of the input pattern as a stable attractor state of the classical optical Hopfield network 406. In this way, the optical control devices 414, 418, and 420 may represent weights for the underlying Hopfield network.

Optical control device 416 comprises a lens, which may be implemented to Fourier transform and/or focus light propagating between the visible neuron lasers 410 and the various other optical control devices 414, 418, and 420. In some implementations, optical control device 416 is distanced from the visible neuron lasers 410 (and/or from the micro-lens array 412) by about one focal length of the lens. Similarly, optical control device 416 may be distanced from optical control device 420 (e.g., a reflective optical control device) by about one focal length of the lens. Example operation of the classical optical Hopfield network 406 can comprise forming an image via the visible neuron lasers 410 and modifying and redirecting the image via the optical control devices 414, 416, 418, and 420 (e.g., Fourier transforming via the lens and scattering and/or redirecting of the light via the optical cross-connects) back toward the visible neuron lasers 410, causing injection-locking and controlled interconnection of the visible neuron lasers 410.

Although FIG. 4 illustrates an example in which the optical control devices 414, 416, 418, and 420 comprise three diffractive optical elements and one lens (which may collectively form an optical cross connect), any quantity of optical control devices of any type may be used to facilitate controlled optical connection among the visible neuron lasers 410, in accordance with the disclosed principles.

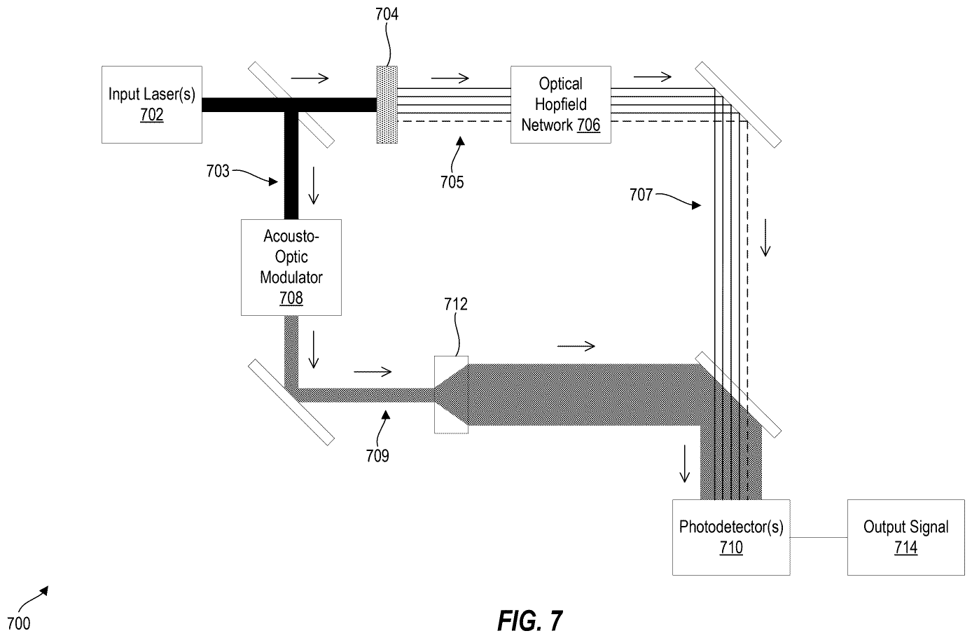

In the example shown in FIG. 4, the classical optical Hopfield network system 400 includes an output system 422, which can be configured to receive light from the classical optical Hopfield network 406 (e.g., via half-reflecting mirror 424) to generate an output signal. In some implementations, the output system 422 also includes one or more wavelength shifting components (e.g., acousto-optic or electro-optic modulators) that receive light from the input laser(s) 402 to produce wavelength-shifted light, which is combined with the light from the classical optical Hopfield network 406 and directed to one or more photodetectors (e.g., a photodiode array). The photodetector(s) can be used to determine the beating heterodyne signal of the wavelength-shifted light and the light received from the classical optical Hopfield network 406, which can provide the basis for the output signal of the classical optical Hopfield network system 400. Additional details concerning an output system for an optical Hopfield network system will be described hereinafter with reference to FIG. 7.

In FIG. 5, the classical optical Hopfield network system 500 includes various components similar to those of the classical optical Hopfield network system 400. For instance, the classical optical Hopfield network system 500 includes an input system 501 configured to provide an input signal to a classical optical Hopfield network 506 and an output system 542 configured to receive light from the classical optical Hopfield network 506 to generate an output signal. The input system 501 includes input laser(s) 502 and spatial light modulator(s) 504.

The classical optical Hopfield network 506 shown in FIG. 5 includes a first subset of visible neuron lasers 510 and a second subset of visible neuron lasers 530 (with accompanying microlens arrays 512 and 532. In some implementations, the first subset of visible neuron lasers 510 and the second subset of visible neuron lasers 530 each include one visible neuron laser per visible neuron of the visible layer for the Hopfield network represented by the classical optical Hopfield network 506. For example, where the underlying Hopfield network design includes n visible neurons in the visible layer, the first subset of visible neuron lasers 510 may include n visible neuron lasers, and the second subset of visible neuron lasers 530 may also include n visible neuron lasers, causing the classical optical Hopfield network 506 to have a total of 2n visible neuron lasers.

FIG. 5 illustrates the classical optical Hopfield network 506 as further including optical control devices 514, 516, 518, 520, 522, and 524, which optically (and bidirectionally) connect the first subset of visible neuron lasers 510 with the second subset of visible neuron lasers 530 in a controlled manner to facilitate injection locking of the visible neuron lasers. FIG. 5 depicts optical control devices 514, 518, 520, and 522 as optical cross-connects and depicts optical control devices 516 and 524 as lenses. In the example shown in FIG. 5, optical control devices 516 and 524 have the same focal length, with both being separated from optical control device 520 by the focal length. As illustrated, optical control device 516 is separated from the first subset of visible neuron lasers 510 (and/or the microlens arrays 512) by the focal length, and optical control device 524 is separated from the second subset of visible neuron lasers 530 (and/or the microlens array 532) by the focal length. One will appreciate, in view of the present disclosure, that this configuration is provided by way of example only and that variations are within the scope of the disclosed subject matter (e.g., any quantity of optical control devices of any type may be used to achieve controlled optical connection among the first subset of visible neuron lasers 510 and the second subset of visible neuron lasers 530).

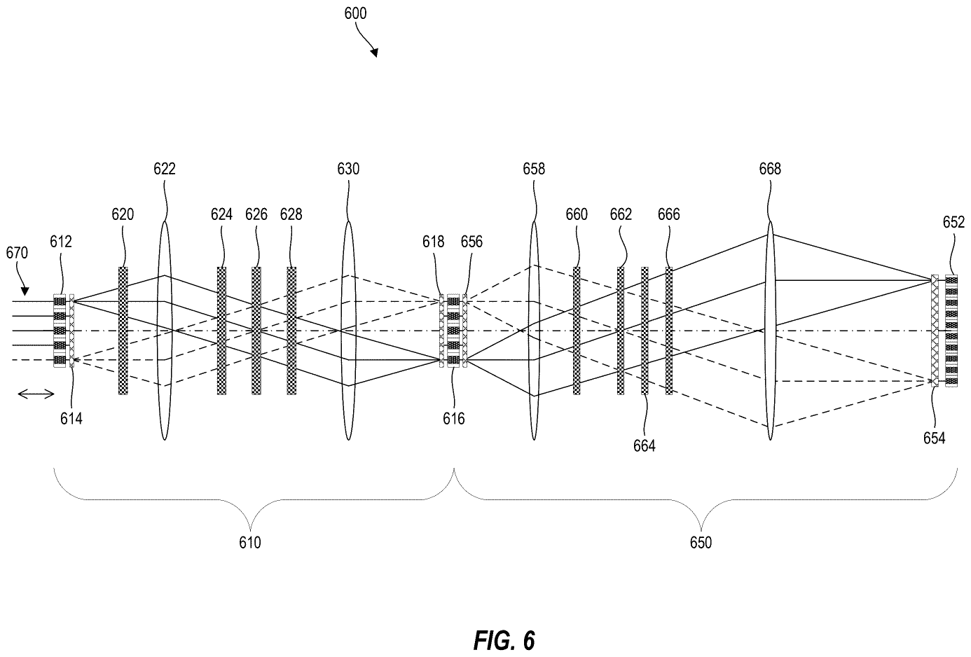

FIG. 6 illustrates a schematic diagram of components of an example hybrid optical Hopfield network 600. In FIG. 6, input light (e.g., from an input system) enters the hybrid optical Hopfield network 600 at region 670, and light output by the hybrid optical Hopfield network 600 exits at region 670 (e.g., for reception by an output system). Similar to the hybrid Hopfield network described hereinabove with reference to FIGS. 1 and 3, which includes aspects of both classical and modern Hopfield networks, the hybrid optical Hopfield network 600 includes aspects of both classical optical Hopfield networks and modern optical Hopfield networks. For instance, FIG. 6 illustrates the hybrid optical Hopfield network 600 as including a classical component 610 and a modern component 650. Similar to the classical optical Hopfield network 506 shown in FIG. 5, the classical component 610 includes a first subset of visible neuron lasers 612 (with accompanying microlenses 614) and a second subset of visible neuron lasers 616 (with accompanying microlenses 618), with optical control devices 620, 622, 624, 626, 628, and 630 optically connecting the first subset of visible neuron lasers 612 to the second subset of visible neuron lasers 616.

The modern component 650 includes hidden neuron lasers 652 (with accompanying microlenses 654) that represent hidden neurons of a hidden layer for the Hopfield network. The hidden neuron lasers 652 can include one hidden neuron laser per hidden neuron of the hidden layer for the Hopfield network represented by the hybrid optical Hopfield network 600. For example, where the underlying Hopfield network design includes x hidden neurons in the hidden layer (where x is less than the full hidden neuron count), the hidden neuron lasers 652 can include x hidden neuron lasers. In some embodiments, the hidden neuron lasers 652 have a greater quantity of lasers than the first subset of visible neuron lasers 612, the second subset of visible neuron lasers 616, or both the first subset of visible neuron lasers 612 and the second subset of visible neuron lasers 616 combined. FIG. 6 illustrates the modern component 650 as further including optical control devices 656, 658, 660, 662, 664, 666, and 668, which may optically couple the visible neurons represented by the second subset of visible neuron lasers 616 to the hidden neurons represented by the hidden neuron lasers 652. The optical control devices can facilitate injection locking of the hidden neuron lasers 652 by light from the second subset of visible neuron lasers 616 (and vice-versa).

Optical control device 656 comprises a microlens array proximate to the second subset of visible neuron lasers 616, which can increase the beam divergence of the light emitted by the second subset of visible neuron lasers 616 to accommodate differences in matrix size between the second subset of visible neuron lasers 616 and the hidden neuron lasers 652. Optical control devices 660, 662, 664, and 666 comprise optical cross-connects and/or scattering layers, which may represent weights for the underlying Hopfield network. The weights may be determined via training processes described hereinabove with reference to FIG. 4. Optical control devices 658 and 668 comprise lenses, which may have focal lengths that are different from one another and different from the focal length of optical control devices 622 and 630 of the classical component 610. The differences in focal lengths can accommodate the larger laser matrix of the hidden neuron lasers 652 relative to the second subset of visible neuron lasers 616. In the example shown in FIG. 6, optical control device 658 has a shorter focal length than that of optical control devices 622, 630, and 668, and optical control device 668 has a longer focal length than that of optical control devices 622, 630, and 658. In FIG. 6, optical control devices 658 and 668 are distanced from optical control device 662 by their respective focal lengths, optical control device 658 is distanced from the second subset of visible neuron lasers 616 by its focal length, and optical control device 668 is distanced from the hidden neuron lasers 652 by its focal length. In the example shown, the optical control devices 660, 662, 664, and 666 include one or more scattering layers that are between the lenses (i.e., optical control devices 658 and 668), where the spatial pixel information from the laser matrices has been translated into k-vector space (e.g., directional angle) information. One will appreciate, in view of the present disclosure, that this configuration is provided by way of example only and that variations are within the scope of the disclosed subject matter. For instance, any quantity of optical control devices of any type (e.g., lenses, diffractive elements, light scattering structures, mirrors, waveguides or other light guiding structures, etc.) may be used to achieve controlled optical connection among the second subset of visible neuron lasers 616 and the hidden neuron lasers 652.

FIG. 7 illustrates a schematic diagram of components of an optical Hopfield network system 700. In the example shown, the optical Hopfield network system 700 includes an input system that has input laser(s) 702 and spatial light modulator(s) 704. The input system is configured to generate an input signal 705 for propagation toward an optical Hopfield network 706. The optical Hopfield network can correspond to a classical optical Hopfield network (e.g., classical optical Hopfield network 406 or 506), a hybrid optical Hopfield network (e.g., hybrid optical Hopfield network 600), or a modern optical Hopfield network (e.g., including the modern component 650 of the hybrid optical Hopfield network 600, with a set of visible neuron lasers and a set of hidden neuron lasers).

In the example shown in FIG. 7, the optical Hopfield network system 700 further includes an output system that has an acousto-optic modulator 708 (or other wavelength-shifting component) and photodetector(s) 710. The acousto-optic modulator 708 is configured to receive light 703 from the input laser(s) 702 and produce wavelength-shifted light 709. The photodetector(s) 710 are configured to receive the wavelength-shifted light 709 and light 707 output by the optical Hopfield network 706 (FIG. 7 depicts optics 712 for adjusting the matrix beam size for the wavelength-shifted light 709). The signal detected by the photodetector(s) 710 can represent the beating heterodyne signal of the wavelength-shifted light 709 and the light 707 from the optical Hopfield network 706, which can be used to generate an output signal 714 representing the output of the optical Hopfield network system 700 (e.g., a retrieved attractor state or result of a memory association or training process). Variations, additions, or substitutions of the components of the optical Hopfield network system 700 shown in FIG. 7 are within the scope of the present disclosure.

### Example Embodiments

Embodiments disclosed herein can include those in the following numbered clauses:
Clause 1. A hybrid Hopfield network system, comprising: a visible layer comprising a plurality of visible neurons, wherein each visible neuron of the plurality of visible neurons is bidirectionally connected with each other visible neuron of the plurality of visible neurons, wherein the visible layer is configured to receive input patterns to facilitate pattern storage or pattern retrieval; a hidden layer comprising a plurality of hidden neurons, wherein each hidden neuron of the plurality of hidden neurons is connected to a quantity of visible neurons from the plurality of visible neurons, wherein a quantity of hidden neurons in the hidden layer is less than a full hidden neuron count, wherein the full hidden neuron count comprises a ratio of (i) a factorial of a quantity of visible neurons in the visible layer to (ii) a product of (a) a factorial of the quantity of visible neurons to which each hidden neuron in the hidden layer is connected and (b) a factorial of a difference between the quantity of visible neurons in the visible layer and the quantity of visible neurons to which each hidden neuron in the hidden layer is connected; a state update module configured to iteratively adjust neuron activations of the visible neurons of the visible layer and the hidden neurons of the hidden layer after reception of an input pattern by the visible layer to facilitate convergence toward a stored attractor state; and an output module configured to provide an output signal based on states of the visible neurons of the visible layer.
Clause 2. The hybrid Hopfield network system of clause 1, wherein the stored attractor state is stored via a training module configured to adjust weights of connections among the visible neurons of the visible layer and the hidden neurons of the hidden layer to facilitate storage of an input pattern as the stored attractor state.
Clause 3. The hybrid Hopfield network system of clause 1, wherein the quantity of hidden neurons in the hidden layer is less than 80% of the full hidden neuron count.
Clause 4. The hybrid Hopfield network system of clause 1, wherein the visible layer, the hidden layer, the state update module, and the output module are represented in computer-executable instructions that are stored by one or more computer-readable recording media and that are executable by one or more processors to facilitate reception of the input pattern by the visible layer and generation of the output signal by the output module.
Clause 5. The hybrid Hopfield network system of clause 1, wherein the visible neurons of the visible layer and the hidden neurons of the hidden layer are represented as a plurality of lasers configured for injection-locked operation.
Clause 6. The hybrid Hopfield network system of clause 5, wherein connections among the visible neurons of the visible layer and the hidden neurons of the hidden layer are represented as one or more optical control devices.
Clause 7. An optical Hopfield network system, comprising: an input system configured to generate an input signal; an optical Hopfield network configured to receive the input signal from the input system, the optical Hopfield network comprising: a plurality of lasers, wherein each laser of the plurality of lasers is configured for injection-locked operation; and one or more optical control devices configured to distribute light output by at least some of the plurality of lasers among at least some of the plurality of lasers in a controlled manner to contribute to injection locking of at least some of the plurality of lasers; and an output system configured to generate an output signal based on light received from the optical Hopfield network.
Clause 8. The optical Hopfield network system of clause 7, wherein the one or more optical control devices comprise one or more lenses and one or more light scattering layers.
Clause 9. The optical Hopfield network system of clause 7, wherein the plurality of lasers comprises at least a set of visible neuron lasers representing visible neurons of a visible layer for a Hopfield network.
Clause 10. The optical Hopfield network system of clause 9, wherein the set of visible neuron lasers comprises one visible neuron laser per visible neuron of the visible layer for the Hopfield network, and wherein the one or more optical control devices includes at least a set of optical control devices that optically connects each visible neuron laser of the set of visible neuron lasers to each other visible neuron laser of the set of visible neuron lasers to contribute to injection locking of each visible neuron lasers of the set of visible neuron lasers.
Clause 11. The optical Hopfield network system of clause 9, wherein the set of visible neuron lasers comprises a first subset of visible neuron lasers and a second subset of visible neuron lasers, wherein the first subset of visible neuron lasers comprises one visible neuron laser per visible neuron of the visible layer for the Hopfield network, wherein the second subset of visible neuron lasers comprises one visible neuron laser per visible neuron of the visible layer for the Hopfield network, and wherein the one or more optical control devices comprises at least a set of optical control devices that optically connects each visible neuron laser of the first subset of visible neuron lasers to each visible neuron laser of the second subset of visible neuron lasers to contribute to injection locking of each visible neuron laser of the second subset of visible neuron lasers.
Clause 12. The optical Hopfield network system of clause 9, wherein the plurality of lasers further comprises a set of hidden neuron lasers representing hidden neurons of a hidden layer for the Hopfield network.
Clause 13. The optical Hopfield network system of clause 12, wherein the set of hidden neuron lasers comprises a greater quantity of lasers than the set of visible neuron lasers.
Clause 14. The optical Hopfield network system of clause 12, wherein the one or more optical control devices comprises at least a set of optical control devices that optically connects each hidden neuron laser of the set of hidden neuron lasers to a quantity of visible neuron lasers of the set of visible neuron lasers to contribute to injection locking of each hidden neuron laser of the set of hidden neuron lasers.
Clause 15. The optical Hopfield network system of clause 14, wherein the set of visible neuron lasers comprises a first subset of visible neuron lasers and a second subset of visible neuron lasers, wherein the first subset of visible neuron lasers comprises one visible neuron laser per visible neuron of the visible layer for the Hopfield network, wherein the second subset of visible neuron lasers comprises one visible neuron laser per visible neuron of the visible layer for the Hopfield network, and wherein the one or more optical control devices comprises an additional set of optical control devices that optically connects each visible neuron laser of the first subset of visible neuron lasers to each visible neuron laser of the second subset of visible neuron lasers to contribute to injection locking of each visible neuron laser of the second subset of visible neuron lasers.
Clause 16. The optical Hopfield network system of clause 15, wherein a quantity of hidden neuron lasers in the set of hidden neuron lasers is less than a full hidden neuron count, wherein the full hidden neuron count comprises a ratio of (i) a factorial of a quantity of visible neurons in the visible layer to (ii) a product of (a) a factorial of the quantity of visible neuron lasers to which each hidden neuron laser in the set of hidden neuron lasers is optically connected and (b) a factorial of a difference between the quantity of visible neurons in the visible layer and the quantity of visible neuron lasers to which each hidden neuron laser in the set of hidden neuron lasers is optically connected.
Clause 17. The optical Hopfield network system of clause 9, wherein the input system comprises: one or more input lasers; and a spatial light modulator configured to direct light output by the one or more input lasers toward the set of visible neuron lasers to contribute to injection locking of the set of visible neuron lasers.
Clause 18. The optical Hopfield network system of clause 17, wherein the output system comprises: an acousto-optic modulator configured to receive light from the one or more input lasers and produce wavelength-shifted light; and one or more photodetectors configured to receive the wavelength-shifted light and the light received from the optical Hopfield network, wherein the output system is configured to generate the output signal based on a beating heterodyne signal of the wavelength-shifted light and the light received from the optical Hopfield network.
Clause 19. An optical Hopfield network system, comprising: an input system configured to generate an input signal; an optical Hopfield network configured to receive the input signal from the input system, the optical Hopfield network comprising: a plurality of lasers, wherein each laser of the plurality of lasers is configured for injection-locked operation, wherein the plurality of lasers comprises: a set of visible neuron lasers representing visible neurons of a visible layer for a Hopfield network, wherein the set of visible neuron lasers comprises a first subset of visible neuron lasers and a second subset of visible neuron lasers, wherein the first subset of visible neuron lasers comprises one visible neuron laser per visible neuron of the visible layer for the Hopfield network, wherein the second subset of visible neuron lasers comprises one visible neuron laser per visible neuron of the visible layer for the Hopfield network; and a set of hidden neuron lasers representing hidden neurons of a hidden layer for the Hopfield network; and one or more optical control devices, the one or more optical control devices comprising: a set of optical control devices that optically connects each hidden neuron laser of the set of hidden neuron lasers to a quantity of visible neuron lasers of the set of visible neuron lasers to contribute to injection locking of each hidden neuron laser of the set of hidden neuron lasers; and an additional set of optical control devices that optically connects each visible neuron laser of the first subset of visible neuron lasers to each visible neuron laser of the second subset of visible neuron lasers to contribute to injection locking of each visible neuron laser of the second subset of visible neuron lasers; and an output system configured to generate an output signal based on light received from the optical Hopfield network.
Clause 20. The optical Hopfield network system of clause 19, wherein a quantity of hidden neuron lasers in the set of hidden neuron lasers is less than a full hidden neuron count, wherein the full hidden neuron count comprises a ratio of (i) a factorial of a quantity of visible neurons in the visible layer to (ii) a product of (a) a factorial of the quantity of visible neuron lasers to which each hidden neuron laser in the set of hidden neuron lasers is optically connected and (b) a factorial of a difference between the quantity of visible neurons in the visible layer and the quantity of visible neuron lasers to which each hidden neuron laser in the set of hidden neuron lasers is optically connected.

### Additional Details Related to the Disclosed Embodiments

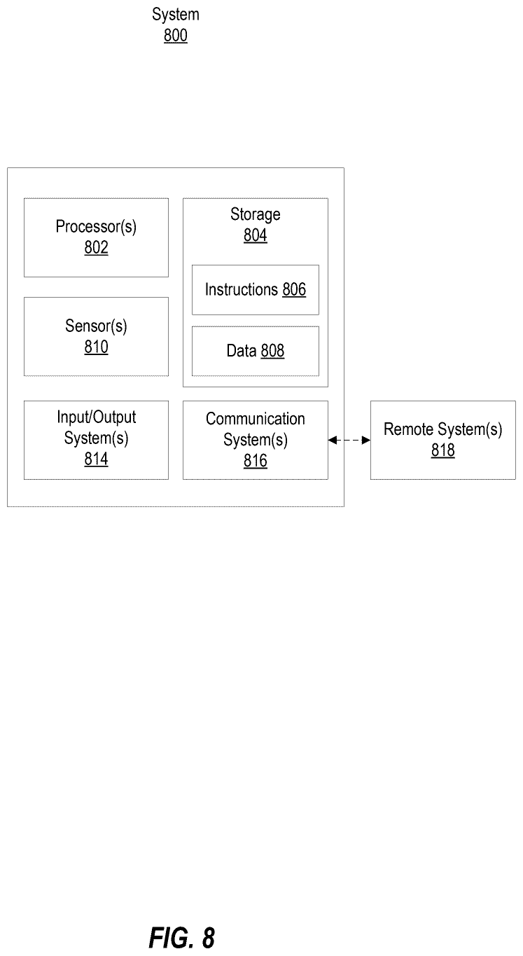

FIG. 8 illustrates various example components of a system 800 that may be used when implementing one or more disclosed embodiments (e.g., control/pump the lasers, to control the spatial light modulator(s) 404, 504, 704, to control the optical cross-connects, to control the acousto-optic modulator 708, to control the photodetector(s) 710 and/or generate the output signal 714, etc.). For example, FIG. 8 illustrates that a system 800 may include processor(s) 802, storage 804, sensor(s) 810, input/output system(s) 814 (I/O system(s) 814), and communication system(s) 816. Although FIG. 8 illustrates a system 800 as including particular components, one will appreciate, in view of the present disclosure, that a system 800 may comprise any number of additional or alternative components.

The processor(s) 802 may comprise one or more sets of electronic circuitries that include any number of logic units, registers, and/or control units to facilitate the execution of computer-readable instructions (e.g., instructions that form a computer program). Processor(s) 802 may take on various forms, such as, by way of non-limiting example, Field-programmable Gate Arrays (FPGAs), application-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

Computer-readable instructions may be stored within storage 804. The storage 804 may comprise physical system memory and may be volatile, non-volatile, or some combination thereof. Furthermore, storage 804 may comprise local storage, remote storage (e.g., accessible via communication system(s) 816 or otherwise), or some combination thereof. Additional details related to processors (e.g., processor(s) 802) and computer storage media (e.g., storage 804) will be provided hereinafter.

In some implementations, the processor(s) 802 may comprise or be configurable to execute any combination of software and/or hardware components that are operable to facilitate processing using machine learning models or other artificial intelligence-based structures/architectures. For example, processor(s) 802 may comprise and/or utilize hardware components or computer-executable instructions operable to carry out function blocks and/or processing layers configured in the form of, by way of non-limiting example, fully connected layers, convolutional layers, pooling layers, recurrent layers, embedding layers, dropout layers, normalization layers, attention layers, transformer layers, flatten layers, and/or others without limitation.

As will be described in more detail, the processor(s) 802 may be configured to execute instructions 806 stored within storage 804 to perform certain actions. The actions may rely at least in part on data 808 stored on storage 804 in a volatile or non-volatile manner.

In some instances, the actions may rely at least in part on communication system(s) 816 for receiving data from remote system(s) 818, which may include, for example, separate systems or computing devices, sensors, and/or others. The communications system(s) 816 may comprise any combination of software or hardware components that are operable to facilitate communication between on-system components/devices and/or with off-system components/devices. For example, the communications system(s) 816 may comprise ports, buses, or other physical connection apparatuses for communicating with other devices/components. Additionally, or alternatively, the communications system(s) 816 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 8 illustrates that a system 800 may comprise or be in communication with sensor(s) 810. Sensor(s) 810 may comprise any device for capturing or measuring data representative of perceivable or detectable phenomena. By way of non-limiting example, the sensor(s) 810 may comprise one or more radar sensors, image sensors, microphones, thermometers, barometers, magnetometers, accelerometers, gyroscopes, and/or others.

Furthermore, FIG. 8 illustrates that a system 800 may comprise or be in communication with I/O system(s) 814. I/O system(s) 814 may include any type of input or output device such as, by way of non-limiting example, a touch screen, a mouse, a keyboard, a controller, and/or others, without limitation. For example, the I/O system(s) 814 may include a display system that may comprise any number of display panels, optics, laser scanning display assemblies, and/or other components.

At least some components of the system 800 may comprise or utilize various types of devices, such as servers, workstations, clusters, pods, edge devices, mobile electronic devices (e.g., smartphones), personal computing devices (e.g., a laptops), wearable devices (e.g., smartwatches, HMDs, etc.), vehicles (e.g., aerial vehicles, autonomous vehicles, etc.), and/or other devices. A system 800 may take on other forms in accordance with the present disclosure.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“laaS”), and deployment models (e.g., private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

As used herein, the term “about”, when used to modify a numerical value or range, refers to any value within 5%, 10%, 15%, 20%, or 25% of the numerical value modified by the term “about”.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We currently claim:

1. A hybrid Hopfield network system, comprising:
a visible layer comprising a plurality of visible neurons, wherein each visible neuron of the plurality of visible neurons is bidirectionally connected with each other visible neuron of the plurality of visible neurons, wherein the visible layer is configured to receive input patterns to facilitate pattern storage or pattern retrieval;
a hidden layer comprising a plurality of hidden neurons, wherein each hidden neuron of the plurality of hidden neurons is connected to a quantity of visible neurons from the plurality of visible neurons, wherein a quantity of hidden neurons in the hidden layer is less than a full hidden neuron count, wherein the full hidden neuron count comprises a ratio of (i) a factorial of a quantity of visible neurons in the visible layer to (ii) a product of (a) a factorial of the quantity of visible neurons to which each hidden neuron in the hidden layer is connected and (b) a factorial of a difference between the quantity of visible neurons in the visible layer and the quantity of visible neurons to which each hidden neuron in the hidden layer is connected;
a state update module configured to iteratively adjust neuron activations of the visible neurons of the visible layer and the hidden neurons of the hidden layer after reception of an input pattern by the visible layer to facilitate convergence toward a stored attractor state; and
an output module configured to provide an output signal based on states of the visible neurons of the visible layer.

2. The hybrid Hopfield network system of claim 1, wherein the stored attractor state is stored via a training module configured to adjust weights of connections among the visible neurons of the visible layer and the hidden neurons of the hidden layer to facilitate storage of an input pattern as the stored attractor state.

3. The hybrid Hopfield network system of claim 1, wherein the quantity of hidden neurons in the hidden layer is less than 80% of the full hidden neuron count.

4. The hybrid Hopfield network system of claim 1, wherein the visible layer, the hidden layer, the state update module, and the output module are represented in computer-executable instructions that are stored by one or more computer-readable recording media and that are executable by one or more processors to facilitate reception of the input pattern by the visible layer and generation of the output signal by the output module.

5. The hybrid Hopfield network system of claim 1, wherein the visible neurons of the visible layer and the hidden neurons of the hidden layer are represented as a plurality of lasers configured for injection-locked operation.

6. The hybrid Hopfield network system of claim 5, wherein connections among the visible neurons of the visible layer and the hidden neurons of the hidden layer are represented as one or more optical control devices.

7. An optical Hopfield network system, comprising:
an input system configured to generate an input signal;
an optical Hopfield network configured to receive the input signal from the input system, the optical Hopfield network comprising:
a plurality of lasers, wherein each laser of the plurality of lasers is configured for injection-locked operation; and
one or more optical control devices configured to distribute light output by at least some of the plurality of lasers among at least some of the plurality of lasers in a controlled manner to contribute to injection locking of at least some of the plurality of lasers; and
an output system configured to generate an output signal based on light received from the optical Hopfield network.

8. The optical Hopfield network system of claim 7, wherein the one or more optical control devices comprise one or more lenses and one or more light scattering layers.

9. The optical Hopfield network system of claim 7, wherein the plurality of lasers comprises at least a set of visible neuron lasers representing visible neurons of a visible layer for a Hopfield network.

10. The optical Hopfield network system of claim 9, wherein the set of visible neuron lasers comprises one visible neuron laser per visible neuron of the visible layer for the Hopfield network, and wherein the one or more optical control devices includes at least a set of optical control devices that optically connects each visible neuron laser of the set of visible neuron lasers to each other visible neuron laser of the set of visible neuron lasers to contribute to injection locking of each visible neuron lasers of the set of visible neuron lasers.

11. The optical Hopfield network system of claim 9, wherein the set of visible neuron lasers comprises a first subset of visible neuron lasers and a second subset of visible neuron lasers, wherein the first subset of visible neuron lasers comprises one visible neuron laser per visible neuron of the visible layer for the Hopfield network, wherein the second subset of visible neuron lasers comprises one visible neuron laser per visible neuron of the visible layer for the Hopfield network, and wherein the one or more optical control devices comprises at least a set of optical control devices that optically connects each visible neuron laser of the first subset of visible neuron lasers to each visible neuron laser of the second subset of visible neuron lasers to contribute to injection locking of each visible neuron laser of the second subset of visible neuron lasers.

12. The optical Hopfield network system of claim 9, wherein the plurality of lasers further comprises a set of hidden neuron lasers representing hidden neurons of a hidden layer for the Hopfield network.

13. The optical Hopfield network system of claim 12, wherein the set of hidden neuron lasers comprises a greater quantity of lasers than the set of visible neuron lasers.

14. The optical Hopfield network system of claim 12, wherein the one or more optical control devices comprises at least a set of optical control devices that optically connects each hidden neuron laser of the set of hidden neuron lasers to a quantity of visible neuron lasers of the set of visible neuron lasers to contribute to injection locking of each hidden neuron laser of the set of hidden neuron lasers.

15. The optical Hopfield network system of claim 14, wherein the set of visible neuron lasers comprises a first subset of visible neuron lasers and a second subset of visible neuron lasers, wherein the first subset of visible neuron lasers comprises one visible neuron laser per visible neuron of the visible layer for the Hopfield network, wherein the second subset of visible neuron lasers comprises one visible neuron laser per visible neuron of the visible layer for the Hopfield network, and wherein the one or more optical control devices comprises an additional set of optical control devices that optically connects each visible neuron laser of the first subset of visible neuron lasers to each visible neuron laser of the second subset of visible neuron lasers to contribute to injection locking of each visible neuron laser of the second subset of visible neuron lasers.

16. The optical Hopfield network system of claim 15, wherein a quantity of hidden neuron lasers in the set of hidden neuron lasers is less than a full hidden neuron count, wherein the full hidden neuron count comprises a ratio of (i) a factorial of a quantity of visible neurons in the visible layer to (ii) a product of (a) a factorial of the quantity of visible neuron lasers to which each hidden neuron laser in the set of hidden neuron lasers is optically connected and (b) a factorial of a difference between the quantity of visible neurons in the visible layer and the quantity of visible neuron lasers to which each hidden neuron laser in the set of hidden neuron lasers is optically connected.

17. The optical Hopfield network system of claim 9, wherein the input system comprises:
one or more input lasers; and
a spatial light modulator configured to direct light output by the one or more input lasers toward the set of visible neuron lasers to contribute to injection locking of the set of visible neuron lasers.

18. The optical Hopfield network system of claim 17, wherein the output system comprises:
an acousto-optic modulator configured to receive light from the one or more input lasers and produce wavelength-shifted light; and
one or more photodetectors configured to receive the wavelength-shifted light and the light received from the optical Hopfield network, wherein the output system is configured to generate the output signal based on a beating heterodyne signal of the wavelength-shifted light and the light received from the optical Hopfield network.

19. An optical Hopfield network system, comprising:
an input system configured to generate an input signal;
an optical Hopfield network configured to receive the input signal from the input system, the optical Hopfield network comprising:
a plurality of lasers, wherein each laser of the plurality of lasers is configured for injection-locked operation, wherein the plurality of lasers comprises:
a set of visible neuron lasers representing visible neurons of a visible layer for a Hopfield network, wherein the set of visible neuron lasers comprises a first subset of visible neuron lasers and a second subset of visible neuron lasers, wherein the first subset of visible neuron lasers comprises one visible neuron laser per visible neuron of the visible layer for the Hopfield network, wherein the second subset of visible neuron lasers comprises one visible neuron laser per visible neuron of the visible layer for the Hopfield network; and
a set of hidden neuron lasers representing hidden neurons of a hidden layer for the Hopfield network; and
one or more optical control devices, the one or more optical control devices comprising:
a set of optical control devices that optically connects each hidden neuron laser of the set of hidden neuron lasers to a quantity of visible neuron lasers of the set of visible neuron lasers to contribute to injection locking of each hidden neuron laser of the set of hidden neuron lasers; and
an additional set of optical control devices that optically connects each visible neuron laser of the first subset of visible neuron lasers to each visible neuron laser of the second subset of visible neuron lasers to contribute to injection locking of each visible neuron laser of the second subset of visible neuron lasers; and
an output system configured to generate an output signal based on light received from the optical Hopfield network.

20. The optical Hopfield network system of claim 19, wherein a quantity of hidden neuron lasers in the set of hidden neuron lasers is less than a full hidden neuron count, wherein the full hidden neuron count comprises a ratio of (i) a factorial of a quantity of visible neurons in the visible layer to (ii) a product of (a) a factorial of the quantity of visible neuron lasers to which each hidden neuron laser in the set of hidden neuron lasers is optically connected and (b) a factorial of a difference between the quantity of visible neurons in the visible layer and the quantity of visible neuron lasers to which each hidden neuron laser in the set of hidden neuron lasers is optically connected.
